(19) United States
(12) Patent Application Publication
(10) Pub. No.: US 2006/0086787 A1
(43) Pub. Date: Apr. 27, 2006

(54) Systems and methods for facilitating purchases and tax recovery

(76) Inventors: Robert O. Roy, Houston, TX (US); Craig J. Watson, Sandy, UT (US); Paul R. Lersch, Houston, TX (US); Mark L. Connors, Porter, TX (US)

Correspondence Address: HARRITY & SNYDER, L.L.P., Suite 300, 11240 Waples Mill Road, Fairfax, VA, 22030, US

(21) Appl. No.: 11/258,089

(22) Filed: Oct. 26, 2005

Related U.S. Application Data
(60) Provisional application No. 60/621,661, filed on Oct. 26, 2004.

(51) Int. Cl. G06K 5/00; G06Q 20/00

(52) U.S. Cl. 235/380; 705/19

(57) ABSTRACT

A method includes storing information associated with at least one purchaser in a database. The information may include discount or rate information to be applied when calculating charges for purchases. The method also includes receiving, from a seller, payment card information associated with the sale of fuel to a first purchaser and determining whether the first purchaser is registered in the database. The method also includes calculating, when the first purchaser is registered in the database, a charge amount based on information stored in the database.

### RELATED APPLICATION

This application claims priority under 35 U.S.C. § 119 based on U.S. Provisional Application No. 60/621,661 filed Oct. 26, 2004, the disclosure of which is hereby incorporated by reference herein.

### BACKGROUND OF THE INVENTION

Commercial industries, such as the aviation industry (e.g., air cargo, corporate and charter aviation), are riddled with many labor intensive, manual processes. For example, aviation companies currently have to pre-arrange fuel releases at each location where refueling occurs. The fuel is typically owned by fuel providers, who often sell the fuel through fixed based operators (FBOs) or refueling companies. The FBO, refueling company or other party associated with selling fuel, referred to herein as the vendor or merchant, may perform the actual pumping of the fuel and may provide other services.

Traditionally, aviation companies do not use credit cards to purchase fuel due to lack of information at the time of purchase, the high cost of acceptance and insufficient lines of credit to accommodate large fuel purchases. In most situations, the process of purchasing fuel from a typical vendor requires the aviation company that wants to purchase fuel to generate a paper purchase order and then provide in some other manner (e.g., via facsimile, e-mail, etc.) the purchase order to the vendor. Since vendors often have different rules associated with purchasing fuel, aviation companies are required to know the particular rules associated with different vendors in order for the purchase order to be accepted.

Since the price of fuel typically fluctuates daily, once a purchase request is made, the vendor must determine the actual cost for the fuel, including any appropriate discounts. For example, the purchaser may get a discount based on the total volume purchased and other factors. The vendor must also determine whether the purchaser is authorized to purchase the desired amount of fuel based on the total cost. The method described above for purchasing fuel is a labor intensive process on the part of both the purchaser and the vendor.

In addition, an aviation company typically reconciles the cost of a flight and generates an invoice for its services to its client shortly after the flight is complete. In many instances, the aviation company gets billed by the vendor for the fuel release after the aviation company has already billed the client for the flight. In this case, the aviation company may end up absorbing the fuel costs or may be forced to bill the client a second time for the fuel costs.

### SUMMARY OF THE INVENTION

According to one aspect, a method includes storing information associated with at least one purchaser in a database, where the information includes discount or rate information to be applied when calculating charges for purchases. The method also includes receiving, from a seller, payment card information associated with the sale of fuel to a first purchaser and determining whether the first purchaser is registered in the database. The method further includes calculating, when the first purchaser is registered in the database, a charge amount based on information stored in the database.

According to another aspect, a system that includes a database, input logic and processing logic is provided. The database is configured to store information associated with a plurality of customers and at least one vendor. The input logic is configured to receive information from a first vendor, where the information includes discount or rate information to be applied to purchases. The input logic is also configured to store the information in the database. The processing logic is configured to receive information identifying a first customer and a purchase made by the first customer and determine whether the first customer is registered in the database. The processing logic is further configured to calculate, when the first customer is registered in the database, a charge amount based in part on the discount or rate information stored in the database.

According to a further aspect, a point of sale system is provided. The point of sale system includes an input device configured to receive information associated with a sale of aviation fuel to a first buyer and receive credit card or debit card information from the first buyer. The point of sale system also includes logic configured to forward information identifying the first buyer to a charge calculating system via a network and receive a charge amount from the charge calculating system.

According to still another aspect, a system that includes an input device and processing logic is provided. The input device is configured to receive information from a first seller, where the information includes discount or rate information to be applied to purchases. The input device is also configured to store at least a portion of the information from the first seller in a database. The processing logic is configured to receive, from the first seller, information identifying a first purchaser and determine whether the first purchaser is registered in the database. The processing logic is further configured to calculate, when the first purchaser is registered in the database, a charge amount based in part on the discount or rate information stored in the database.

### BRIEF DESCRIPTION OF THE DRAWINGS

The accompanying drawings, which are incorporated in and constitute a part of the specification, illustrate an embodiment of the invention and, together with the description, explain the invention. In the drawings,

FIG. 1 is a diagram of an exemplary system in which methods and systems consistent with the invention may be implemented.

FIG. 2 is an exemplary block diagram of the server of FIG. 1.

FIG. 3 is a flow diagram illustrating exemplary processing associated with automating the purchasing of fuel.

FIG. 4 illustrates an exemplary interface screen provided by the fuel module of FIG. 1.

FIG. 5 illustrates an exemplary database maintained by the fuel module of FIG. 1.

FIG. 6 is a simplified exemplary block diagram illustrating the flow of information with respect to authorizing a purchase.

### DETAILED DESCRIPTION

The following detailed description of implementations consistent with the invention refers to the accompanying drawings. The same reference numbers in different drawings may identify the same or similar elements. Also, the following detailed description does not limit the invention. Instead, the scope of the invention, is defined by the appended claims and their equivalents.

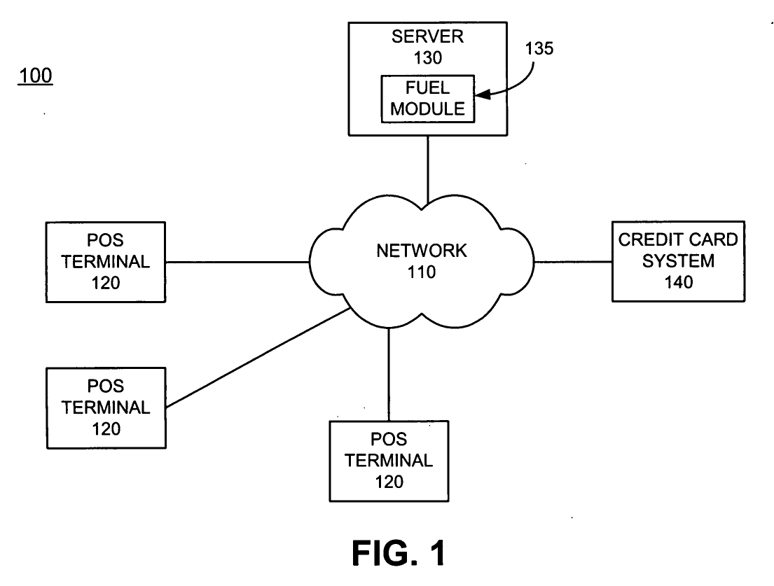

FIG. 1 is a block diagram of an exemplary system 100 in which methods and systems consistent with the invention may be implemented. System 100 may include network 110, point of sale (POS) terminals 120, server 130 and credit card system 140. The exemplary configuration illustrated in FIG. 1 is provided for simplicity. It should be understood that a typical system may include more or fewer devices than illustrated in FIG. 1. For example, three POS terminals 120 and a single credit card system 140 are illustrated in FIG. 1. In other systems, the number of POS terminals 120 and credit card systems 140 may be much larger.

Network 110 may include one or more wired and/or wireless networks that are capable of receiving and transmitting data. For example, network 110 may include one or more public switched telephone networks (PSTNs) or other type of switched network. Network 110 may also include packet switched networks, such as the Internet, an intranet, a local area network (LAN), a wide area network (WAN), or another type of network that is capable of transmitting data from a source device to a destination device.

POS terminals 120, consistent with the invention, may represent a vendor (e.g., an FBO) associated with providing fueling services and other services. POS terminals 120 may include a device at which credit card transactions may be accepted. For example, each POS terminal 120 may include a credit card reader that is able to read information stored on a magnetic strip located on a credit or debit card. Each POS terminal 120, consistent with the invention, may also capture additional information associated with a proposed purchase, as described in more detail below.

Server 130 may include any server/computing device that is able to connect to network 110 and transmit and receive data via network 110. Server 130 may include a firewall (not shown) that provides security-related services for server 130. Server 130 may also include more than on server device or may include a single server device distributed over system 100.

Server 130, consistent with the invention, may include fuel module 135. Fuel module 135, as described in more detail below, stores information associated with various fuel purchasers and calculates appropriate billing information, as described in more detail below. Fuel module 135 also provides for data collection and report generation, as described in more detail below.

Credit card system 140 may represent any conventional credit card processing system in which credit card transactions are processed. For example, credit card system 140 may represent a bank associated with an issued credit card, such as a MasterCard, VISA, American Express, etc. Credit card system 140 may include one or more computers/systems that determine whether a credit card transaction is authorized in a conventional manner.

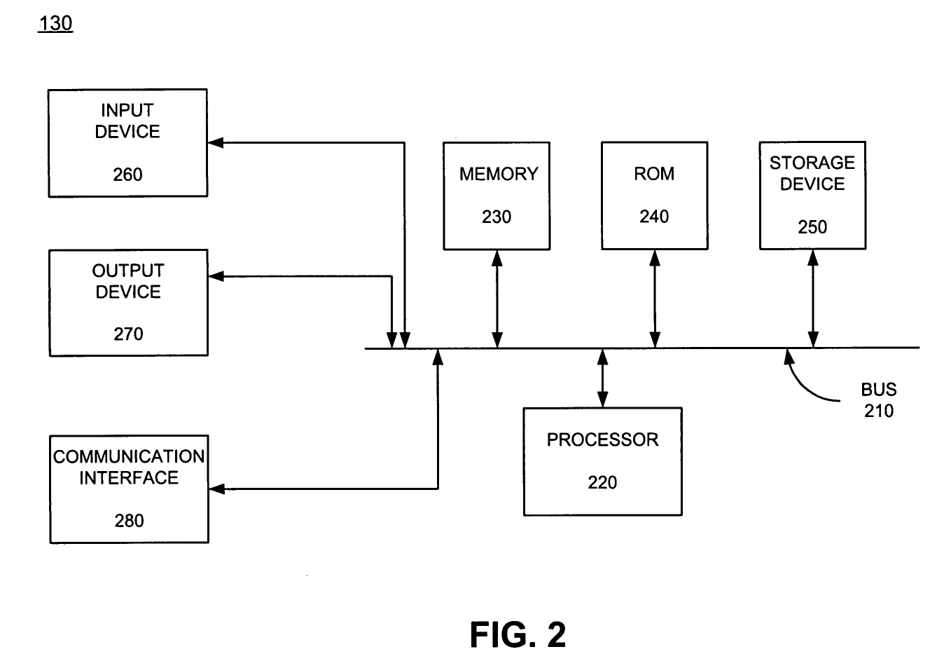

FIG. 2 illustrates an exemplary configuration of server 130 in an implementation consistent with the invention. Other configurations may alternatively be used. Server 130 may include a bus 210, a processor 220, a memory 230, a read only memory (ROM) 240, a storage device 250, an input device 260, an output device 270, and a communication interface 280. Bus 210 permits communication among the components of server 130.

Processor 220 may include any type of processor or microprocessor that interprets and executes instructions. Memory 230 may include a random access memory (RAM) or another dynamic storage device that stores information and instructions for execution by processor 220. Memory 230 may also be used to store temporary variables or other intermediate information during execution of instructions by processor 220.

ROM 240 may include a conventional ROM device and/or another static storage device that stores static information and instructions for processor 220. Storage device 250 may include a magnetic disk or optical disk and its corresponding drive and/or some other type of magnetic or optical recording medium and its corresponding drive for storing information and instructions.

Input device 260 may include one or more conventional mechanisms that permit an operator to input information to server 130, such as a keyboard, a mouse, a pen, voice recognition and/or biometric mechanisms, etc. Output device 270 may include one or more conventional mechanisms that output information to the operator, including a display, a printer, one or more speakers, etc. Communication interface 280 may include any transceiver-like mechanism that enables server 130 to communicate with other devices and/or systems. For example, communication interface 280 may include a modem or an Ethernet interface to a LAN. Alternatively, communication interface 280 may include other mechanisms for communicating via a network.

Server 130, consistent with the invention, provides a platform through which transactions from POS terminals 120 are processed prior to transmission to credit card system 140. According to an exemplary implementation, server 130 performs processing associated with transactions from POS terminals 120 in response to processor 220 executing sequences of instructions contained in memory 230. Such instructions may be read into memory 230 from another computer-readable medium, such as storage device 250, or from a separate device via communication interface 280. It should be understood that a computer-readable medium may include one or more memory devices or carrier waves. Execution of the sequences of instructions contained in memory 230 causes processor 220 to perform the acts that will be described hereafter. In alternative embodiments, hard-wired circuitry may be used in place of or in combination with software instructions to implement the present invention. Thus, the invention is not limited to any specific combination of hardware circuitry and software.

POS terminals 120 and server 130 are illustrated in FIG. 1 as being connected via network 110. In alternative implementations, POS terminals 120 and server 130 may be connected directly to each other, connected via a LAN, connected via a private network, etc. In addition, the connection between POS terminals 120 and server 130 may be a secured connection, such as a secure sockets layer (SSL) connection, a virtual private network (VPN) connection, etc. In still other alternative implementations, the functions performed by POS terminals 120 and server 130, described in more detail below, may be performed by a single device/platform.

### Exemplary Processing

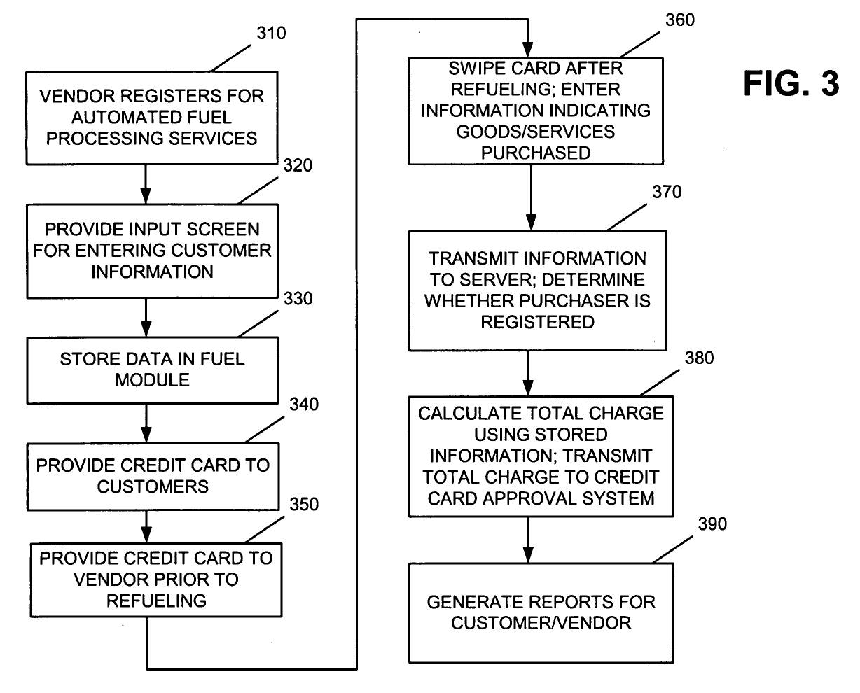

FIG. 3 is a flow diagram illustrating an exemplary process for automating the purchasing of fuel consistent with the principles of the invention. The following description focuses on simplifying the process of purchasing fuel by aviation companies. It will be appreciated that the techniques described herein are equally applicable to other types of purchases.

Processing may begin by a vendor (e.g., an FBO) registering or signing up for automated fuel purchase related services provided by fuel module 135 (act 310). For example, a vendor may connect to server 130 via network 110 by entering an Internet address (e.g., a website address or a uniform resource locator (URL)) in a browser being executed by a computer device associated with the vendor. Alternatively, a sales person associated with server 130 may contact the vendor (or vice versa) and manually register the vendor for fuel purchase related services.

Assume that the vendor has contacted server 130 via network 110 and has registered for fuel purchase related services provided by fuel module 135. In this case, fuel module 135 may provide a user interface (UI) to the vendor that includes a screen for allowing the vendor to input information associated with the vendor's customers (act 320).

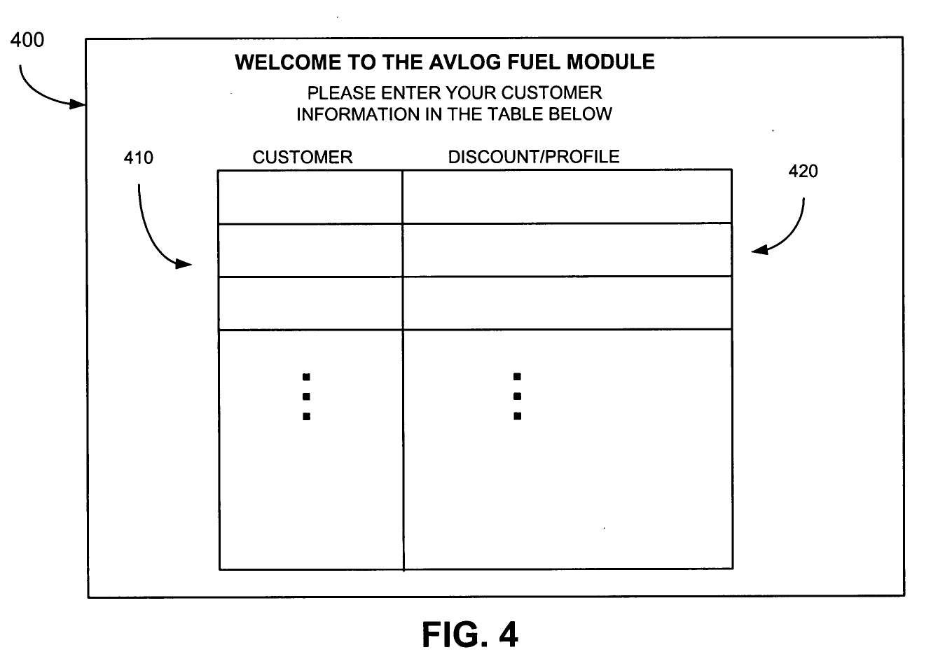

For example, FIG. 4 illustrates an exemplary input screen 400 provided by fuel module 135 to the vendor. As illustrated in FIG. 4, input screen 400 includes a greeting and requests that the vendor enter information regarding its customers in a table. The table includes a customer area 410 and a discount/profile area 420. The vendor may enter a customer name and/or identifier (ID) in area 410 and a corresponding discount or rate associated with that customer in area 420.

For example, the discount information may indicate a percentage discount applied to that particular customer's fuel purchases. The discount may be based on a number of factors, such as total volume purchased by that customer over a period of time, the type of fuel, the type of aircraft, etc.

Alternatively, the discount information may indicate a rate for each gallon of fuel that is purchased. This rate may be pre-negotiated by the customer and vendor. In addition, the rate may vary based on the amount of fuel purchased over a predetermined period. For example, the rate may be one price for a first number of gallons purchased each month and a second price (e.g., a lower price) for any number of gallons over the first number. In each case, the discount or rate information may be input by the vendor based on the particular customer and the discount/rate information may also be modified by the vendor over time, if necessary.

In alternative implementations, the vendor may provide the customer name/ID and discount/profile information to fuel module 135 in other ways. For example, the vendor may provide the customer name and discount information to a sales person associated with fuel module 135 over the telephone, in a hard copy (i.e., paper) format or soft copy (disk) format, in a data file transmitted to server 130 or in any other convenient manner.

In each case, the information provided by the vendor includes the relevant customer name/ID and discount/profile information. If the data is provided in paper format, the data may be input to fuel module 135 by a party associated with fuel module 135. In each case, fuel module 135 may store the information for later use associated with a fuel purchase (act 330).

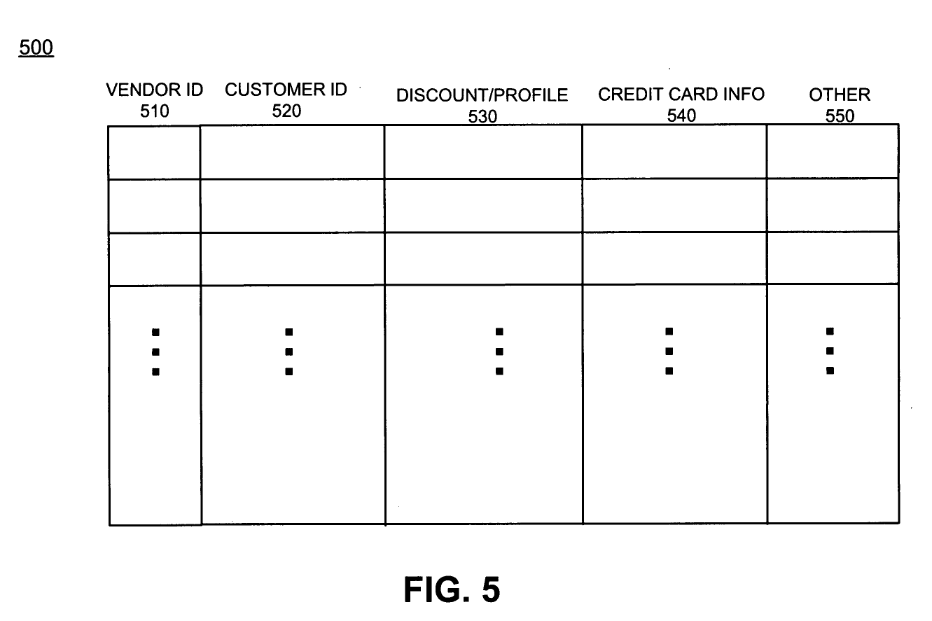

Fuel module 135 may store information for a number of vendors in a similar manner. For example, FIG. 5 illustrates database 500 stored by fuel module 135. Database 500 may be stored at server 130 in, for example, storage device 250 (FIG. 2). Referring to FIG. 5, database 500 includes a vendor ID field 510, a customer ID field 520, a discount/profile field 530, a credit card information field 540 and other field 550. The vendor ID field 510 may store identifiers that uniquely identify each vendor. As discussed above, an aviation company may deal with a different vendor at each airport and each vendor may service a large number of customers.

Customer ID field 520 may be a unique identifier assigned by the vendor to each of its customers and may correspond to the customer name/ID provided by the vendor in area 410 of input screen 400. Discount/profile field 530 may store the relevant discount for that particular customer and may correspond to the information provided by the vendor in area 420 of input screen 400. The credit card information field 540 may store a credit card number, debit card number or other payment card number that uniquely identifies a particular customer and/or a particular aircraft. A credit card may be provided to the customer, as described in more detail below, for facilitating fuel related purchases. Other field 550 may store another identifier used to identify a customer and/or a particular aircraft associated with a customer. For example, other field 550 may store an aircraft tail number that uniquely identifies the aircraft of a particular customer. Other field 550 may also include other pertinent information, such as fuel prices based on the type of fuel and geographic area, tax information (e.g., local, state and/or federal tax per gallon) based on the type of fuel and particular jurisdiction, etc. Since fuel prices fluctuate frequently, database 500 may be updated one or more times daily to take into account relevant information, such as changes in fuel prices. The fuel prices may be updated by the respective vendors or by an administrator associated with maintaining database 500 in fuel module 135.

Assume that fuel module 135 has received and stored information from a number of individual vendors in database 500. Further assume that after receiving the customer information, each customer is provided with a commercial credit card (or credit card application) (act 340). The credit card may be customized to provide features that are particularly tailored to purchasing fuel and may be provided to the customer by, for example, an entity associated with fuel module 135. The credit card may be a MasterCard, VISA, American Express or some other commercial credit card. In each case, fuel module 135 may store customers' credit card information (e.g., account number, limit information, etc.) in field 540 in database 500.

After receiving the credit card, a purchaser, such as an aviation company, may use the credit card to facilitate the purchasing of fuel from a vendor. For example, assume that an aviation company pilot wants to purchase fuel from a vendor. In this case, the purchaser provides the credit card to the vendor prior to refueling (act 350). Alternatively, in some implementations consistent with the invention, the pilot may provide the aircraft tail number to the vendor since the aircraft tail number may have already been associated with the credit card number stored in database 500. For example, the aircraft tail number may be stored in other field 550.

The vendor may then refuel the aircraft. After refueling, the vendor, the pilot or another party may swipe the credit card through a conventional card reader at POS terminal 120 (act 360). An attendant at POS terminal 120 may also enter information representing the goods/services purchased by the pilot. For example, the attendant may enter information at POS terminal 120 indicating the type of fuel purchased and the total number of gallons purchased. It should be understood that the credit card may be swiped before or after the attendant at POS terminal 120 enters the information representing the goods/services that were purchased.

After entering this information, the POS terminal 120 transmits this information to server 130 via network 110 (act 370). As discussed above, the credit card may be tailored to fuel purchases. Therefore, instead of the credit card information and other purchase information being immediately transmitted to credit card system 140 for approval, the credit card information and the other information entered at POS terminal 120 may be transmitted to server 130 to determine the actual charges for the fuel.

Fuel module 135 may receive the information transmitted from POS terminal 120 and determines whether the swiped credit card (or tail number) represents a customer that is registered in fuel module 135 (act 370). That is, fuel module 135 looks up the credit card information and determines whether the credit card information corresponds to an entry stored in field 540 of database 500. Alternatively, the attendant at POS terminal 120 may transmit the aircraft tail number along with the other information (e.g., total number of gallons, price/gallon, etc.). In this case, fuel module 135 may determine whether the tail number matches information stored in other field 550.

If fuel module 135 determines that the credit card/tail number is not stored in database 500, this indicates that the purchaser is not registered or participating in the program provided by fuel module 135. In this case, if the credit card is a valid credit card, fuel module 135 may notify POS terminal 120 and/or the vendor associated with POS terminal 120 that the purchaser is not registered in fuel module 135. The POS terminal 120 may then perform a conventional point of sale transaction and transmit the relevant information to the appropriate credit card authorizing system.

Assume that fuel module 135 determines that the credit card number/tail number is stored in database 500, indicating that the purchaser is registered in the program provided by fuel module 135. In this case, fuel module 135 looks up the required information in database 500 to arrive at the total charge (act 380).

For example, fuel module 135 may identify the customer's discount in discount/profile field 530 in database 500. Fuel module 135 may also identify the type of fuel purchased and the total number of gallons purchased based on, for example, information provided by POS terminal 120. Fuel module 135 may then calculate the total charge based on the price per gallon, total number of gallons and the appropriate discount. When determining the appropriate price per gallon, fuel module 135 may determine the effective price per gallon by adding the appropriate tax per gallon based on information stored in other field 550 of database 500. Alternatively, the tax per gallon may be provided to fuel module 135 by POS terminal 120. In either case, fuel module 135 factors in the appropriate tax and any other miscellaneous fees charged by the vendor. These miscellaneous fees may be stored in the discount/profile field 530 or other field 550 of database 500. Alternatively, these fees may be provided by POS terminal 120.

Fuel module 135 may then transmit the total charge amount, along with the credit card account information, to credit card system 140 (act 380). Credit card system 140 may then determine whether to approve the purchase in a conventional manner. That is, credit card system 140 may determine whether the total charge amount is within the purchaser's limit. In some implementations, credit card system 140 may request authorization from the bank/institution that issued the credit card in order to authorize the transaction. In other implementations, credit card system 140 may store the necessary information to authorize the transaction itself.

In either case, once the transaction is authorized, credit card system 140 informs POS terminal 120 that the transaction is authorized for the amount determined by fuel module 135.

POS terminal 120 may then generate a memo or receipt for the purchaser (e.g., the pilot in the example above). The actual charge may also be emailed and/or made available to the purchaser, such as the aviation company owning the aircraft, via a reporting system executed by fuel module 135.

For example, fuel module 135 may track all purchases made by each customer. Fuel module 135 may then generate a report for each purchaser indicating the amount charged per week, month, year, etc., along with the savings provided by the discounts given by the vendor (act 390). This enables purchasers to be able to track fuel costs in a simple, easy to understand manner. These reports may also be customized based on various user preferences that may be provided to fuel module 135 to enable the customers to be aware of total fuel costs in an easy to understand manner. For example, the customized reports may include line item details relevant to a particular customer, including tax reports as described in more detail below.

Fuel module 135 may also generate reports for each vendor (act 390). These reports may tracks purchases on a weekly, monthly, yearly basis, etc. These reports may also break down purchases on a per customer basis. These reports may also be customized based on each particular vendor's preferences to enable the vendor to track purchases and purchasers in an efficient manner. In each case, the reports provided to both the customers and vendors provide a simplified tracking method by which fuel purchases and sales can be tracked.

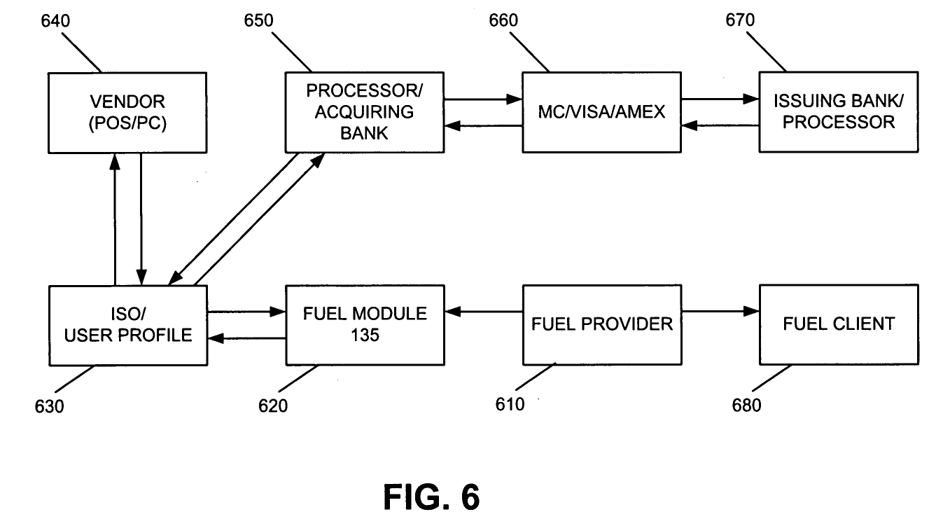

FIG. 6 is a simplified exemplary block diagram illustrating the flow of information with respect to authorization a purchase in an exemplary implementation. Referring to FIG. 6, a fuel provider (box 610) provides information regarding its customers to a fuel module 135 (box 620). Fuel module 135 may store this information in a database as user profile information (box 630). In this case, the party responsible for managing fuel module 135 may be an Independent System Operator (ISO) that owns and/or manages the operation of fuel module 135 on behalf of its customers (e.g., vendors). After a vendor, such as an FBO, has provided goods/services to an aviation company, the vendor may enter the information via its POS system (box 640). In some implementations, the vendor's POS system may include a personal computer (PC) based system that allows the vendor to enter the sales information via a web-enabled interface. The web-enabled interface may be provided by fuel module 135 and may use graphic and/or text input areas that facilitate entry of the sales information. The vendor may transmit the information to the ISO (box 630) and/or fuel module 135.

The ISO and/or fuel module 135 may then calculate the appropriate charges, including any applicable discounts, and may send an authorization request to a processor/acquiring bank (box 650) (e.g., a bank that processes credit card transactions from a vendor's (e.g., an FBO's) POS system.

The acquiring bank requests authorization from the appropriate credit card company (box 660) (e.g., MasterCard, VISA, American Express, etc.). The credit card company may then send an authorization request to the issuing bank that issued the credit card (box 670) to determine if the purchase is within the purchaser's limit. The issuing bank may then send an authorization response back to vendor via, for example, the credit card company (box 660), the acquiring bank (box 650) and the ISO (box 630), as illustrated in FIG. 6. The fuel provider (box 610) may also send pricing information to a fuel client (box 680). The fuel client may be the purchaser, payer and/or card owner associated with purchased fuel. The fuel pricing information may include the price of fuel at various locations and may be stored by the fuel client to ensure that final invoice information matches the fuel pricing information provided to the fuel client. In the manner described above, the transaction regarding calculating charges that may include appropriate discounts operates transparently with respect to the vendor. That is, the vendor simply provides information regarding a sale to the ISO/fuel module 135, which then performs the processing necessary to calculate actual charges.

Implementations consistent with the invention have been described above with the example of presenting a card (e.g., a credit card, debit card, etc.) to a vendor or merchant (e.g., an FBO) for payment. In some implementations, the vendor may own the fuel. In other implementations, however, the fuel may be owned by another entity. In this case, the entire value of the purchased fuel may not be paid to the vendor.

For example, if the fuel is being pumped at an FBO on behalf of a fuel supplier, the FBO will get a fee for pumping the fuel. This fee is known as an “into plane fee”. Fuel module 135, consistent with the invention, may be configured to have the ability to pay more than one entity associated with each fuel purchase. In this case, fuel module 135 may be programmed to automatically allot payment associated with the fuel purchase to both the FBO pumping the fuel and the fuel supplier and possibly one or more other entities associated with the fuel or fuel purchase.

The examples below provide exemplary illustration of a number of typical airport fuel sales scenarios and payment associated with fuel sales. It should be understood that these scenarios are exemplary only and other scenarios may exist. In each case, fuel module 135 may facilitate payment related to the fuel purchase transaction.

### EXAMPLE 1

### Retail Sale

A. FBO sells product & services directly to the customer (with or without a discount). This price includes, fuel, taxes, (State, County, Federal, airport, city municipality, environment, lust tax, pollutant tax, sales taxes by percent and/or per gallon), and into plane (I/P) fees. It should be understood that every airport has different fees. In this case, fuel module 135 may direct the entire payment to the FBO.

### EXAMPLE 2

### Retail Minus a Discount

A. FBO sells their product at a discount directly to the customer. This is usually done with loyal and home-based customers.

B. FBO sells their product at a discount using a third party, e.g., MultiService, AvCard, Air Routing, Universal Weather, Jepperson, etc., and may also sell their product at a discount to an oil company.

In this example, fuel module 135 may direct a portion of the purchase price to the FBO for their service and a portion of the purchase price to the third party. This split billing and multiple settlements capability enhances the functionality and vendors' satisfaction with the use of fuel module 135.

### EXAMPLE 3

### Resellers

This contract fuel category is handled in numerous ways. For example, assume JJR Fuel Co. (JJR) is a company involved in providing fuel.

A. JJR buys fuel directly from a major or independent oil company on the airport. This is known as a buy back. JJR negotiates an I/P fee with the FBO to take JJR's fuel and put it in the aircraft. Under these circumstances, the FBO will bill JJR for the I/P service only.

Under this scenario, JJR may want fuel module 135 to direct a portion of the purchase price to the major oil company, a portion of the purchase price to the FBO and direct the balance of the purchase price to JJR. Alternatively, JJR may want fuel module to pay JJR and JJR will pay the major oil company and the FBO directly. Fuel module 135 may also bill the client (e.g., the customer buying the fuel).

B. JJR has its own fuel inventory at the airport. In this case, JRR may buy fuel in bulk via truckload or pipeline. In this case, JJR may negotiate with the FBO for I/P fees and other services.

Under this scenario, JJR may direct fuel module 135 to pay JRR 100% of the purchase price and JRR would pay the FBO and/or the oil company providing them the fuel directly. Fuel module 135 would also bill the customer buying the fuel accordingly.

In each of the above examples, fuel module 135 allots the proper payment regarding the fuel purchase to one or more entities involved in the fuel purchase, based on the particular preference of parties involved in the fuel purchase. This helps eliminate paperwork and streamlines the payment process for all parties involved.

In some implementations consistent with the invention, fuel module 135 may also track taxes paid by customers when purchasing fuel. Fuel module 135 may also generate reports for customers indicating the amount of taxes paid. This may significantly simplify the customers' ability to later reclaim, when appropriate, some or all of the paid taxes.

For example, in the aviation cargo and charter industry, companies are often able to reclaim taxes that they have paid on fuel purchases since they are paying taxes on the revenue they collect from their clients/customers. Fuel is a part of the cost of doing business. Depending on where the fuel is purchased, there can be many taxes charged, such as federal, state, city, county, etc. Currently, cargo and charter companies typically have to go through every invoice or receipt and add up the total taxes paid and then submit a claim to attempt to reclaim the respective taxes.

In addition, not all taxes paid can be reclaimed because there are different laws that govern each location at which vendors operate. For example, a cargo company flying out of JFK Airport may need to pay city and state tax on the amount of fuel utilized flying out of New York. The cargo company can later reclaim the portion of city and state tax associated with the remaining fuel which was not used while flying in New York. 5Currently, individuals have to track all the various taxes paid by sorting through every receipt/invoice. This is a very labor-intensive process and can involve thousands of receipts. In addition, the amount of taxes reclaimed can be substantial and can increase profitability and productivity

Fuel module 135, consistent with the invention, may automate the process of calculating taxes paid on fuel. Fuel module 135 may collect this information at the time of purchase and may automatically calculate the total taxes paid over a period of time for each customer. Fuel module 135 may also generate various reports to sort the tax information and assist customers in reclaiming taxes.

In one implementation, the tax information may be made available to a customer for a fee. In other implementations, the tax information may be provided without charge to the customer. In addition, the tax information/reports may be provided to the customer electronically, such as via the Internet. In some implementations, fuel module 135 may automatically generate the necessary report(s) or form(s) for submission to the appropriate entity to which the claim for refund is to be submitted.

### CONCLUSION

Systems and methods consistent with the invention facilitate purchases by customers. An advantage of the invention is that the automated processing performed by fuel module 135 eliminates a large amount of the manual and paper processing performed in conventional fuel purchases. For example, the use of fuel module 135 may eliminate the need for generating purchase orders and invoices, providing check payments, performing bill collection and reconciliation associated with conventional fuel purchases. Another advantage of the invention is that using a commercial credit card provides much faster payment to the seller and simplified payment procedures for the buyer. Still another advantage of the invention is that the manual process of collecting tax information and generating reports can be eliminated or substantially reduced, thereby increasing productivity and profitability. Automating the tax information collection may also reduce the amount of errors as compared to manually performing these tasks.

In this disclosure, there is shown and described preferred embodiments of the invention, but, as aforementioned, it is to be understood that the invention is capable of use in various other combinations and environments and is capable of changes or modifications within the scope of the inventive concept as expressed herein.

For example, implementations of the invention have been described above with respect to fuel purchases by aviation companies. It should be understood that the techniques described herein may also be applicable to other types of purchases.

For example, implementations of the invention may be applicable to any types of business/industry that require conventional invoice generation, such as manufacturing, maritime, etc. Further, implementations of the invention may be applicable to any business/industry in which billing information, such as price and/or discounts associated with a purchase, may frequently change. In these cases, a module similar to module 135 may store the appropriate information and may be used to calculate the actual cost associated with a purchase. Implementations consistent with the invention are also not limited to any particular credit card. For example, any commercial credit card may be used to purchase goods/services in implementations consistent with the invention. In addition, private credit cards and debit cards may also be used in implementations consistent with the invention.

In addition, while series of acts have been described with respect to FIG. 3, the order of the acts may be varied in other implementations consistent with the invention. Moreover, non-dependent acts may be implemented in parallel.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects of the invention were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit, a field programmable gate array or a microprocessor, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The scope of the invention is defined by the claims and their equivalents.

What is claimed is:

1. A method, comprising:
storing information associated with at least one purchaser in a database, the information including discount or rate information to be applied when calculating charges for purchases;
receiving, from a seller, payment card information associated with the sale of fuel to a first purchaser;
determining whether the first purchaser is registered in the database; and
calculating, when the first purchaser is registered in the database, a charge amount based on information stored in the database.

2. The method of claim 1, further comprising:
forwarding the charge amount to a credit card approval system.

3. The method of claim 1, wherein the payment card information comprises credit card or debit card information.

4. The method of claim 1, further comprising:
generating a report for the first purchaser based on purchases made over a predetermined period.

5. The method of claim 1, further comprising:
generating a report for the seller based on sales made over a predetermined period.

6. The method of claim 1, further comprising:
determining taxes paid by the first customer for purchases made by the first customer.

7. The method of claim 6, further comprising:
providing information regarding the taxes paid to the first customer.

8. The method of claim 1, wherein the receiving comprises:
receiving the payment card information via a point of sale system.

9. The method of claim 1, wherein the discount or rate information comprises information associated with calculating a price for fuel.

10. A system, comprising:
a database configured to store information associated with a plurality of customers and at least one vendor;
input logic configured to:
receive information from a first vendor, the information including discount or rate information to be applied to purchases, and
store the information in the database; and
processing logic configured to
receive information identifying a first customer and a purchase made by the first customer,
determine whether the first customer is registered in the database, and
calculate, when the first customer is registered in the database, a charge amount based in part on the discount or rate information stored in the database.

11. The system of claim 10, wherein the information identifying the first customer comprises credit card information or debit card information associated with the first customer.

12. The system of claim 10, wherein the information identifying the first customer comprises an aircraft tail number associated with the first customer.

13. The system of claim 10, wherein the database is further configured to store tax information.

14. The system of claim 13, wherein the processing logic is further configured to:
calculate taxes paid by the first customer.

15. The system of claim 10, wherein the database is further configured to store fuel type information.

16. The system of claim 10, wherein the processing logic is further configured to:
forward the charge amount to a credit card processing system or to the first vendor.

17. The system of claim 10, wherein the processing logic is further configured to:
generate at least one report for the first vendor, the report including information identifying a plurality of sales made over a predetermined period of time.

18. The system of claim 10, wherein the processing logic is further configured to:
generate a report for the first customer, the report including information identifying a plurality of purchases made over a predetermined period of time and taxes paid for each of the plurality of purchases.

19. The system of claim 10, wherein the processing logic is further configured to:
direct a payer to pay more than one entity associated with the purchase made by the first customer.

20. A system for calculating charges associated with purchases, comprising:
means for storing information associated with a plurality of customers, the information including discount information or rate information;
means for receiving information identifying a first one of the customers;
means for accessing a database to determine whether the first customer is registered with the system; and
means for calculating, when the first customer is registered with the system, a charge based on information stored in the database.

21. A point of sale system, comprising:
an input device configured to:
receive information associated with a sale of aviation fuel to a first buyer, and
receive credit card or debit card information from the first buyer; and
logic configured to
forward information identifying the first buyer to a charge calculating system via a network, and
receive a charge amount from the charge calculating system.

22. The point of sale system of claim 21, wherein the logic is further configured to:
forward the charge amount to a credit card approval system.

23. The point of sale system of claim 21, wherein the received charge amount factors discount information to the sale to generate the charge amount and wherein the discount information is provided to the charge calculating system by an entity associated with the point of sale system.

24. A system, comprising:
an input device configured to:
receive information from a first seller, the information including discount or rate information to be applied to purchases, and
store at least a portion of the information from the first seller in a database; and
processing logic configured to
receive, from the first seller, information identifying a first purchaser,
determine whether the first purchaser is registered in the database, and
calculate, when the first purchaser is registered in the database, a charge amount based in part on the discount or rate information stored in the database.

25. The system of claim 24, wherein the processing logic is further configured to:
calculate taxes associated with the charge amount.

26. The system of claim 24, further comprising:
an output device configured to:
forward the charge amount to a credit card approval system.

27. The system of claim 24, further comprising:
an output device configured to:
forward the charge amount to the first seller.

28. The system of claim 24, wherein the information identifying a first purchaser comprises an aircraft identifier.
